(19) United States
(12) Patent Application Publication
(10) Pub. No.: US 2017/0353509 A1
(43) Pub. Date: Dec. 7, 2017

(54) ENHANCED ROSTER FOR A SCHEDULED COLLABORATION SESSION

(71) Applicant: Polycom, Inc., San Jose, CA (US)

(72) Inventor: Deep Subhash Pai, Pune (IN)

(21) Appl. No.: 15/221,352

(22) Filed: Jul. 27, 2016

(30) Foreign Application Priority Data
Jun. 1, 2016 (IN) 201631018911

(51) Int. Cl. H04L 29/06; H04L 29/08

(52) U.S. Cl. CPC H04L 65/403; H04L 67/24; H04L 65/1069; H04L 65/1076

(57) ABSTRACT

An enhanced roster for a scheduled collaboration system provides information about invitees that have joined but left a collaboration session and invitees that have not yet joined the collaboration session. A collaboration tool interfaces with a scheduling system and a presence and location system to obtain useful information to insert into the roster, so that the enhanced roster can display information that may be of use to the host or other participants in the collaboration session. As events occur or people join or leave the session, the updated information in the enhanced roster may be updated.

### TECHNICAL FIELD

The present invention relates to the field of collaboration sessions, and in particular to a technique of providing information about invited participants in a scheduled collaboration session.

### BACKGROUND ART

A collaboration session is defined as an audio, video, content (or a combination of such) session between multiple parties. If such a session is scheduled beforehand, then it is considered a scheduled session.

Scheduling a session typically involves the host of the session using a scheduling tool (e.g., Outlook® Calendar) to specify a time, date, subject, agenda, and a list of participants (required or optional) that are invited to the scheduled session. (OUTLOOK is a registered trademark of Microsoft Corporation.) When the session starts, there is no simple way for the host (or other participants) to find out who was invited, who has not joined, and why a missing invitee has not joined.

Conventional collaboration tools provide a roster which contains information about participants that have joined the session along with their info such as name, profile image, email, etc. A host who wants to find out information about missing participants has to compare the roster with the scheduling system (e.g., Outlook Calendar) and the presence status of the participants in the Presence tool (e.g., Microsoft Skype® for Business (SKYPE is a registered trademark of Microsoft Corporation)). Many times the host will have to contact (or attempt to contact) the missing participant via instant messaging (IM) or phone to find out if the missing participant is going to join the session or why the person has not yet joined the session. Providing a easier way to obtain that information would be desirable.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a block diagram illustrating a system for providing an enhanced roster for a collaboration tool according to one embodiment.

FIG. 2 is a high-level flowchart illustrating a technique for enhancing a roster for a collaboration tool according to one embodiment.

FIG. 3 is a screenshot of an enhanced roster for a collaboration tool according to one embodiment.

FIG. 4 is a collection of enhanced roster entries for a collaboration tool according to one embodiment.

FIG. 5 is a block diagram of a computer system for use in implementing an enhanced roster for a collaboration tool according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

The terms “a,” “an,” and “the” are not intended to refer to a singular entity unless explicitly so defined, but include the general class of which a specific example may be used for illustration. The use of the terms “a” or “an” may therefore mean any number that is at least one, including “one,” “one or more,” “at least one,” and “one or more than one.”

The term “or” means any of the alternatives and any combination of the alternatives, including all of the alternatives, unless the alternatives are explicitly indicated as mutually exclusive.

The phrase “at least one of” when combined with a list of items, means a single item from the list or any combination of items in the list. The phrase does not require all of the listed items unless explicitly so defined.

As used herein, the term “a computer system” can refer to a single computer or a plurality of computers working together to perform the function described as being performed on or by a computer system.

As used herein, the term “processing element” can refer to a single hardware processing element or a plurality of hardware processing elements that together may be programmed to perform the indicated actions. The hardware processing elements may be implemented as virtual hardware processing elements of a virtual programmable device hosted on a physical hardware device. Instructions that when executed program the processing element to perform an action may program any or all of the processing elements to perform the indicated action. Where the processing element is one or more multi-core processors, instructions that when executed program the processing element to perform an action may program any or all of the multiple cores to perform the indicated action.

As used herein, the term “medium” can refer to a single physical medium or a plurality of media that together store the information described as being stored on the medium.

As used herein, the term “memory” can refer to a single memory device or a plurality of memory devices that together store the information described as being stored on the medium. The memory may be any type of storage device, including random access memory, read-only memory, optical and electromechanical disk drives, etc.

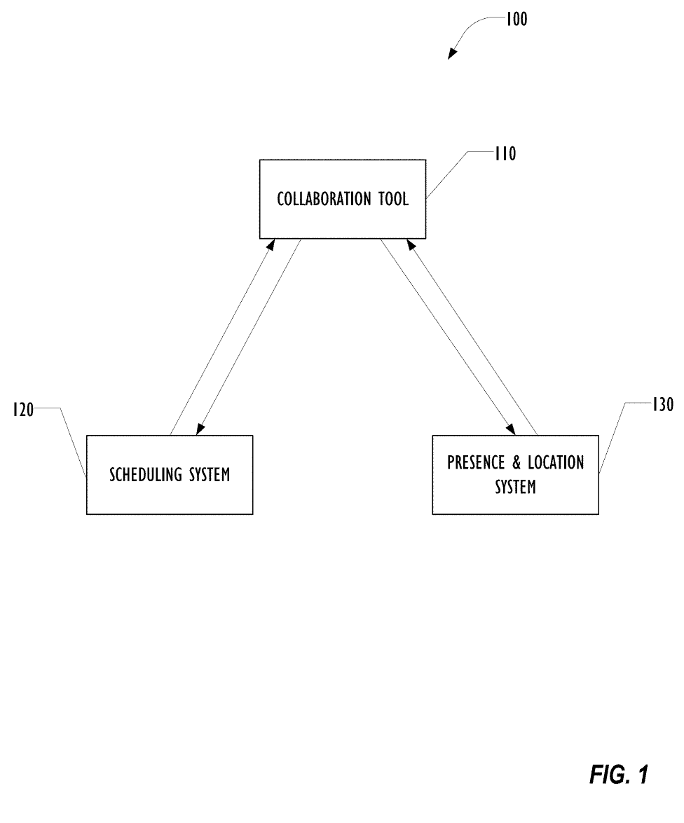

As illustrated in FIG. 1, an enhanced collaboration system 100 includes a collaboration tool 110 capable of displaying an enhanced roster may interface with a scheduling system 120, such as a Microsoft Exchange system providing Outlook calendars for participants in the collaboration sessions, as well as a presence and location system 130. Although a single scheduling system 120 and a single presence and location system 130 are illustrated in FIG. 1 for clarity, any number of scheduling systems 120 and presence and location systems 130 may be used. For example, where participants may be part of multiple enterprises, each having its own scheduling system 120, the collaboration tool 110 may interface with each of the scheduling systems 120 as needed to obtain details such as the list of users for the scheduled collaboration session. The presence and location system may include calendar systems such as Outlook calendars, instant messaging systems, such as Microsoft Skype for Business (formerly known as Lync® (LYNC is a registered trademark of Microsoft Corporation), telephone systems, including voice over Internet Protocol (VOIP) systems, location systems, such as WiFi or geolocation systems, information provided by wearable devices, etc. Any device or system that may provide information about the presence or location of an invited participant in the collaboration session may be interfaced with the collaboration tool 110 for providing presence and location information. In some scenarios, a single system may provide both scheduling information and presence and location information to the collaboration tool 110.

A collaboration system may involve one or more servers as well as one or more endpoints for the participants in a collaboration session. The collaboration tool 110 may be implemented in the server and the endpoints. For example, in some scenarios, the server may not have access to all of the scheduling system 120 or presence and location system 130, but the endpoint, such as a mobile phone may. In such a scenario, the endpoint may collect the data for use with the enhanced roster and provide the data to the server. In other scenarios, the server may have access to the scheduling system 120 and presence and location system 130 and may not need data from the endpoints. In still other scenarios, different endpoints may have different capabilities and the server may collect different data from different endpoints, while the server obtains different data for some endpoints that the server does for others. In some embodiments, the collaboration tool 110 may allow recording the roster and changes to the roster, independently of whether the collaboration session itself is recorded.

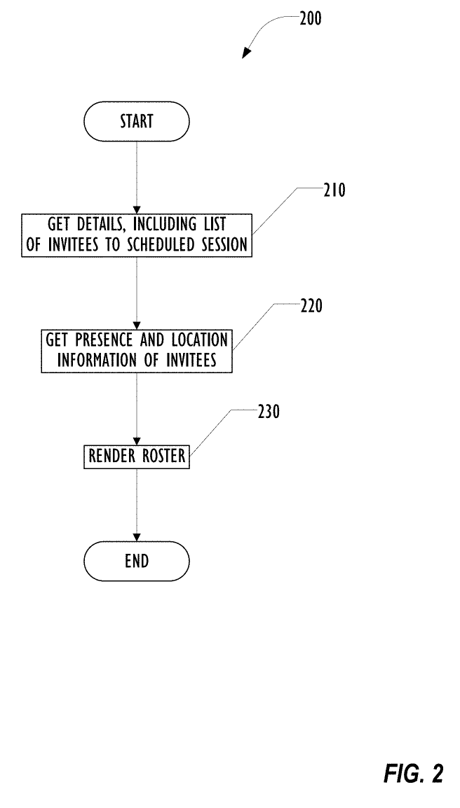

FIG. 2 is a flowchart 200 illustrating a technique for generating an enhanced roster according to one embodiment. In block 210, the collaboration tool 110 may get the details of the scheduled collaboration session. These details may include a list of invitees to the scheduled session. The invitees may be invited to attend the session in one or more meeting rooms and via audio- or video-conferencing systems in multiple locations, including telephone conference calling. In one embodiment, the collaboration tool may store some or all of the scheduling information, or may interface with the scheduling system 120 to obtain the scheduling details, including the list of invitees. The roster may thus be built by the collaboration tool 110 with information on all scheduled attendees. Then in block 220, the collaboration tool 110 may interface with one or more presence and location systems 130 to gather presence and location information for each of the invitees, adding the presence and location information to the roster. Finally, in block 230 the collaboration tool 110 may render the roster in a user interface for a host of the collaboration session. In some embodiments, any participant of the collaboration session may see the enhanced roster. In other embodiments, only certain participants, such as a meeting convenor, may see the enhanced roster; other participants see only a roster of current participants, without the enhanced roster information.

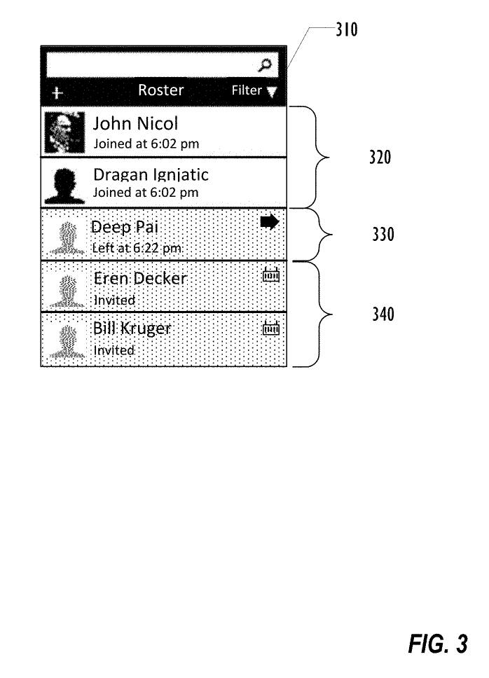

An example of using the scheduling system 120 is to show the list of all the invited participants in the roster and designate them separately by showing who has not yet joined the session. FIG. 3 is a screenshot of an enhanced roster 310 according to one embodiment. The roster 310 in this example shows a list of 5 invitees to a session. Two roster entries 320 are indicated as corresponding to two invitees present in the session. In one embodiment, the roster entries 320 contain information about when the corresponding participant joined the session. Various embodiments may provide other information about the current participants, such as images or icons corresponding to the participants, their names, and any other desired information.

In the example of FIG. 3, entry 330 indicates a former participant in the session, who attended for some portion of the session, but has left the session. In some embodiments, the entry 330 may indicate when the former participant left the session, as well as any other information corresponding to the former participant, such as the information provided for the current participants. For example, the entry 330 may include information such as when the former participant last or originally joined the session, how long the participant was in the session, etc., including combinations of different information elements. In some embodiments, a graphical visual cue may be provided in the entry 330, such as an outward pointing arrow, to make a graphical indication that the corresponding person has left the session, allowing quick recognition of the “gone” status of the former participant without needing to read textual information such as a departure time. Any graphical or visual cue or indication may be used, such as color, shading, etc., in addition to or instead of an icon or graphical object. The visual cue in some embodiments may be a textual indicator, such as “Left at 6:22 pm.” Any combination of indicators may be used to cue someone looking at the roster 310 that the corresponding person has left the collaboration session. For example a departed participant's entry may be grayed out or faded instead of or in addition to a graphical or textual indication of the departed participant's status. The indications and their arrangements illustrated in FIG. 3 are illustrative and by way of example only, and any other indications or arrangement of indications may be used.

Because participants may come and go during a collaboration session, an entry in the roster may change status between that of a present participant or attendee and a former participant or attendee, as often as that participant joins or leaves the session.

Entries 340 of FIG. 3 illustrate invited attendees that have not yet joined the collaboration session. In the illustrated example, the invitees are identified by name and flagged as “invited.” In addition, as with the visual cue provided in the “departed” entries, a visual cue, textual cue, or both may be indicate that the invitee has not yet joined the conference. The visual cue may include color, shading, icons, text, or any other desired way of indicating the “not yet joined” status of the invitee. For example a bar or other area in the entry may be colored differently, depending on the status of the invitee or former participant.

In some embodiments, grouping may be employed to display expandable and collapsible groups of participants or invitees, so that all of the not present participants may be collapsed into a single group entry for “not present” that may use similar visual cues as the individual “not present” entries to indicate the status of the entire group, without taking space in the roster for each such person. A person authorized to expand a collapsed group may click or otherwise select the group entry and cause it to expand into entries for the members of the group. Similarly the person could select a group entry that is expanded and cause it to collapse into just the group entry to save space in the roster display. Embodiments may use an expanded or collapsed state for the group of entries as a default display, which may be configurable.

Any desired ordering of invitees may be provided, and the user of the roster may be provided controls to rearrange or regroup the roster entries as desired, or to filter the roster. For example, the roster may be sorted, either by default or by a user-activated control, with the current participants at the top of the roster, former participants in the middle, and not yet joined invitees at the bottom. Any arrangement may be allowed or provided. Filtering may be provided to allow the user of the roster to see only certain subsets of the roster, such as only those people who have not yet joined the session, or only people having certain user-configured characteristics.

The information in the roster of FIG. 3 is not static, but may change as people join or leave the collaboration session, as events occur, or as relevant information corresponding to invitees changes. For example, a person carrying a WiFi-capable mobile device may be automatically detected as entering (or leaving) a meeting room associated with the collaboration session and the roster updated accordingly. In another example, a person running late to a meeting could send a message to the collaboration tool that he or she is running late, but will be there—very soon, in 10 minutes, etc.—and the roster may be updated to reflect the information in that message in the entry corresponding to that person. Preferably, the roster automatically updates as people come and go, but embodiments may use semi-static displays that update only upon a request to refresh the display.

Machine learning techniques may be used to learn information about participants. For example, over time, the system may learn that a participant at point A usually takes X minutes to arrive at point B, and can update the roster information to make use of the learned information.

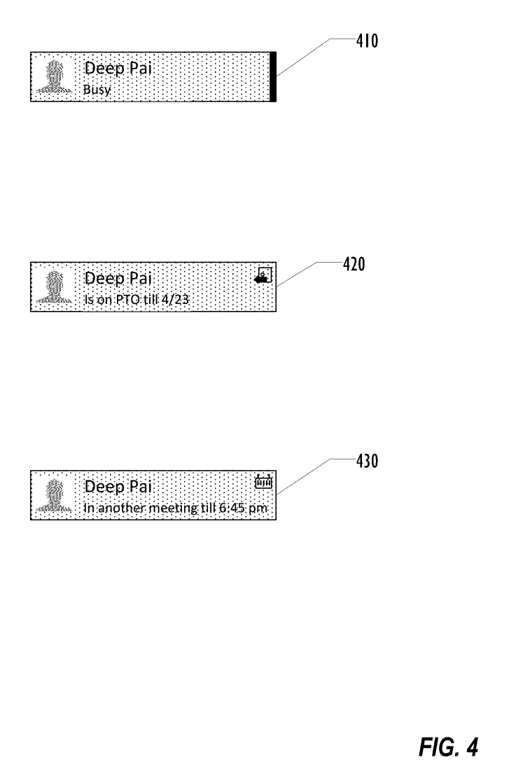

Although as illustrated in FIG. 3 not-yet-joined participants are merely indicated as “invited,” embodiments may use the information from the scheduling or presence and location systems 120, 130 to provide other indications of interest. Three such example entries are illustrated in FIG. 4. Entry 410 indicates that the corresponding invitee is “busy.” This person has not joined because he or she is currently busy with something else, based on the presence information obtained from a relevant presence system 130. Entry 420 indicates that the corresponding invitee is on PTO (paid time off) until 4/22, Entry 430 indicates that the corresponding invitee is in another meeting until 6:45 pm, using information collated from presence and calendar information to inform other participants that this invitee is running late from a previous meeting, for example. The entries of FIG. 4 are illustrative and by way of example, and any other status information obtainable by the collaboration tool 110 may be included in the roster user interface as desired.

Embodiments may control what information in the roster participants may see, based on roles or other criteria. For example, an embodiment may allow only the host to see status information about the participants, while non-host participants only see the list of names on the roster. In another example, registered participants may see the status information, while guest participants may not. Any desired set of controls may be imposed on the roster information.

In addition, some embodiments may allow an invitee to control what information is provided to the roster for privacy or other security concerns. The collaboration tool may allow a user to define preferences to control access to the data, such as giving (or denying) access to the user's scheduling information in the scheduling system 120 or presence or location information for the user in the presence and location system. The preferences may be time of day based or use other types of rules to control access. For example, a user may not wish to have location information provided to the roster when the user is in particular places or types of places. In some embodiments, individualized controls may be provided that allow an invitee to control individually who can see what about that person. Similarly, embodiments may allow a host to control individually what each invitee is able to see in the roster.

These various indicators (and others) may be generated based on information received from the scheduling system 120, the presence and location system 130, or both. In some embodiments, where location information is available, an indication that the invitee is en-route may be provided, including information on an expected arrival time. Or the indication may show the current location of the invitee. Any useful or desired information about the invitee that is obtainable from the scheduling and presence and location systems 120, 130 may be employed in the roster entry for assistance to the person viewing the roster 310.

Although a single collaboration tool 110 is illustrated in FIG. 1, multiple systems may be connected and used to generate and display the enhanced roster. For example, one computer system may provide an audio or video conferencing system, while another system communicating with the conferencing system may provide the roster information to participants or to the conferencing system for providing to participants. One example of such a collaboration tool would be a Polycom RealPresence® Distributed Media Application (DMA). (REALPRESENCE is a registered trademark of Polycom, Inc.) The collaboration tool 110 may use existing application programming interfaces (APIs) of the respective scheduling systems 120 (such as Google Calendar, Outlook Calendar, etc.) to collect scheduling information for use in the roster 310. Similarly, the collaboration tool 110 may use existing APIs to obtain information from presence and location systems 130 such as Skype for Business, Outlook Calendar, wearable devices, radio-frequency identification (RFID) tags, WiFi, and geolocation information such as provided by devices containing geographic positioning satellite (GPS) or other similar receivers. Although existing APIs may be used, some embodiments may provide special purpose APIs for use by collaboration tools 110, as desired. For example, some embodiments may include protocols for automatically messaging a missing invitee to gather additional information about the invitee's ability to attend or allowing the not-yet-joined invitee to send a message to the session, such as encouraging them to start without the missing person, or requesting that the meeting not start until the missing person arrives. In another example, a new API may be used to add other options to calendar reminders other than to dismiss the reminder or to snooze it, such as an option to send a message to say something like, “I'll be there in 5 minutes.” That message can then be reflected in the roster of the meeting.

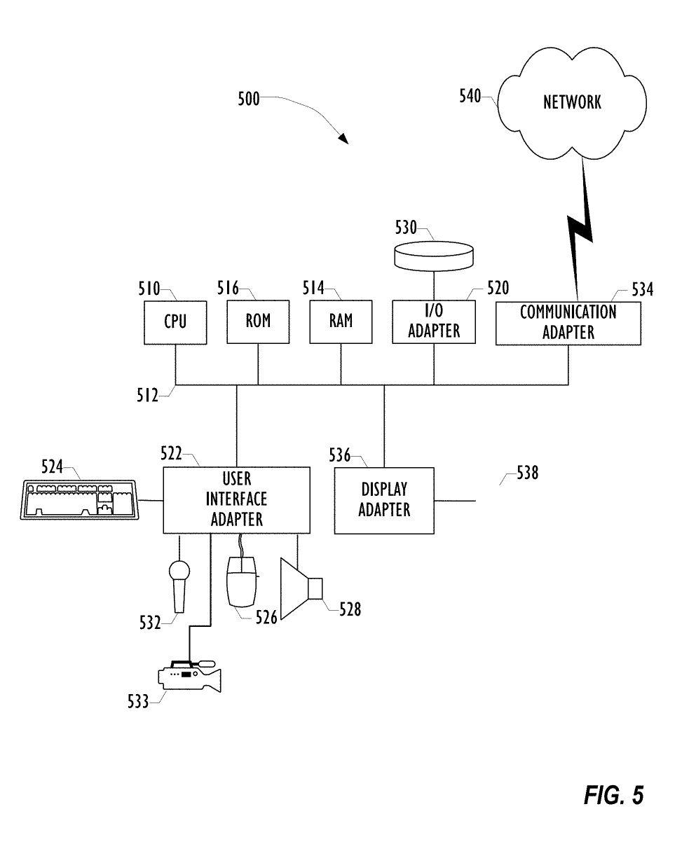

FIG. 5 is a block diagram illustrating a programmable device 500 that may be used for implementing any of the collaboration tool 110, scheduling system 120, or presence and location tools 130. The programmable device 500 may include one or more processors 510, read-only memory (ROM) 516, random access memory (RAM) 514, an I/O adapter 520, connected to a storage device 530, a communication adapter 534 for connecting the programmable device 500 to one or more networks 540, a user interface adapter 522, and a display adapter 536 connected to a display 538. The user interface adapter 522 may allow user interaction devices such as a keyboard 524, a microphone 532, a video camera 533, a mouse 526, and one or more speakers 528. Any other devices may be included, and although only one or each type of component is illustrated in FIG. 5 for clarity, any number of any component may be deployed as desired. As illustrated in FIG. 5, an interconnect 512 connects various components of the programmable device 500. Any type of interconnect may be used, including a bus, a point-to-point link, etc., and multiple interconnects may be used, some of which connect to certain groups of components, while others connect to other groups of components.

Each of the collaboration tool 110, scheduling system 120, and presence and location systems 130 may be implemented as hardware, software, firmware, or any combination thereof. One or more computer readable media may be used to store instructions that when executed by one or more of the processors 510 cause at least some of those processors to perform the techniques described above. The computer readable media may be one or more physical media that together hold the instructions, and may include magnetic media, such as hard discs, optical media, such as CDROMs, or any other type of media that may be used by the programmable device for delivery and storage of the software or firmware. In addition, the instructions may be stored in memory such as ROM 516 or RAM 514.

Having all the information in the roster makes managing a meeting very easy. A host of the meeting can easily see who has not joined yet and why. The additional information about why someone has not joined is also useful for a host to decide if the host should wait for that user or move ahead without the missing person. By putting the additional information into the roster, non-productive time spent at the start of a meeting can be reduced. In addition, by recording the roster information and its changes over time, analytics may be performed on the collaboration session later, even if the collaboration session itself was not recorded.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A collaboration system configured to provide a roster of all invitees to a collaboration session, comprising:
a processing element;
a memory, coupled to the processing element, on which are stored instructions, comprising instructions that when executed cause the processing element to:
obtain information about invitees to a collaboration session from a scheduling system;
compile a roster of the invitees, including invitees not participating in the collaboration session;
indicate in the roster whether each invitee in the roster is participating in the collaboration session; and
display the roster to participants in the collaboration session.

2. The collaboration system of claim 1, wherein the instructions that when executed cause the processing element to display the roster comprise instructions that when executed cause the processing element to:
display all invitees in the roster to a first subset of the participants in the collaboration session; and
display a subset of the invitees in the roster to a second subset of the participants in the collaboration session.

3. The collaboration system of claim 2, wherein the first subset of the participants comprises a host participant.

4. The collaboration system of claim 2, wherein the second subset of the participants is determined based on a role designation of the participants.

5. The collaboration system of claim 1, wherein the instructions that when executed cause the processing element to indicate in the roster whether each invitee in the roster is participating in the collaboration session comprise instructions that when executed cause the processing element to:
obtain information from a presence and location system corresponding to an invitee; and
insert an indication that an invitee is not a participant into a roster entry corresponding to the invitee, responsive to the information.

6. The collaboration system of claim 1, wherein the instructions that when executed cause the processing element to indicate in the roster whether each invitee in the roster is participating in the collaboration session comprise instructions that when executed cause the processing element to:
obtain information from a presence and location system corresponding to an invitee; and
insert an indication of why an invitee is not a participant into a roster entry corresponding to the invitee, responsive to the information.

7. The collaboration system of claim 1, wherein the instructions that when executed cause the processing element to indicate in the roster whether each invitee in the roster is participating in the collaboration session comprise instructions that when executed cause the processing element to:
indicate when an invitee stopped participating in the collaboration session in a roster entry corresponding to the invitee.

8. A non-transitory computer readable medium, on which is stored software for displaying an improved roster of invitees to a collaboration session, comprising instructions that when executed cause a collaboration a processing element of a computing system to:
obtain information about invitees to a collaboration session from a scheduling system;
compile a roster of the invitees, including invitees not participating in the collaboration session; and
indicate in the roster whether each invitee in the roster is participating in the collaboration session.

9. The computer readable medium of claim 8, wherein the instructions further comprise instructions that when executed cause the processing element to:
display all invitees in the roster to a first subset of the participants in the collaboration session; and
display a subset of the invitees in the roster to a second subset of the participants in the collaboration session,
wherein the subset of the invitees comprises invitees that are not participating in the collaboration session.

10. The computer readable medium of claim 9, wherein the first subset of the participants comprises a host participant.

11. The computer readable medium of claim 9, wherein the second subset of the participants is determined based on a role designation of the participants.

12. The computer readable medium of claim 8, wherein the instructions that when executed cause the processing element to indicate in the roster whether each invitee in the roster is participating in the collaboration session comprise instructions that when executed cause the processing element to:
obtain information from a presence and location system corresponding to an invitee; and
insert an indication that an invitee is not a participant into a roster entry corresponding to the invitee, responsive to the information.

13. The computer readable medium of claim 8, wherein the instructions that when executed cause the processing element to indicate in the roster whether each invitee in the roster is participating in the collaboration session comprise instructions that when executed cause the processing element to:
obtain information from a presence and location system corresponding to an invitee; and
insert an indication of why an invitee is not a participant into a roster entry corresponding to the invitee, responsive to the information.

14. The computer readable medium of claim 8, wherein the instructions that when executed cause the processing element to indicate in the roster whether each invitee in the roster is participating in the collaboration session comprise instructions that when executed cause the processing element to:
indicate when an invitee stopped participating in the collaboration session in a roster entry corresponding to the invitee.

15. A method for displaying an enhanced roster of invitees to a collaboration session, comprising:
collecting scheduling information from a scheduling system;
collecting presence or location information from a presence and location system;
updating a roster for a collaboration session based on the scheduling information and the presence or location information; and
displaying the roster to participants in the collaboration session.

16. The method of claim 15, wherein updating the roster comprises:
identifying invitees to the collaboration session from the scheduling information;
identifying which invitees are participating in the collaboration session from the presence or location information; and
indicating in the roster whether each invitee in the roster is participating in the collaboration session.

17. The method of claim 15, wherein displaying the roster comprises:
displaying all invitees in the roster to a first subset of the participants in the collaboration session; and
displaying a subset of the invitees in the roster to a second subset of the participants in the collaboration session.

18. The method of claim 17,
wherein the first subset of the participants comprises a host participant; and
wherein the second subset of the participants is determined based on a role designation of the participants.

19. The method of claim 15, wherein updating the roster comprises:
inserting an indication that an invitee is not a participant into a roster entry corresponding to the invitee, responsive to the presence or location information; and
inserting an indication of why an invitee is not a participant into a roster entry corresponding to the invitee, responsive to the presence or location information or the scheduling information.

20. The method of claim 15, wherein updating the roster comprises:
modifying the roster as invitees leave or join the collaboration session.
